(19) United States
(12) Patent Application Publication
(10) Pub. No.: US 2004/0121749 A1
(43) Pub. Date: Jun. 24, 2004

(54) System throughput enhancement using an intelligent channel association in the environment of multiple access channels

(75) Inventors: Jian Cui, Acton, MA (US); David Shoemaker, Boxborough, MA (US); John Trotter, Berkeley Heights, NJ (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Engim, Inc., Acton, MA

(21) Appl. No.: 10/703,198

(22) Filed: Nov. 6, 2003

Related U.S. Application Data
(60) Provisional application No. 60/424,406, filed on Nov. 6, 2002.

(51) Int. Cl. H04B 17/00; H04B 1/10; H04Q 7/24; H04M 3/00

(52) U.S. Cl. 455/226.1; 455/226.2; 455/296; 455/418; 370/338

(57) ABSTRACT

A Channel Association method and apparatus for a wireless Network increases data throughput by intelligently associating clients to channels. Data rates are assigned to channels and clients with a similar data rate are associated to the same channel. The association is based on the client's distance from a host, the received power of each client and the performance of the client at the host.

### RELATED APPLICATION

This application claims the benefit of U.S. Provisional Application No. 60/424,406, filed on Nov. 6, 2002. The entire teachings of the above application are incorporated herein by reference.

### BACKGROUND OF THE INVENTION

A wireless Local Area Network (LAN) protocol allows mobile clients to find other mobile clients and access points, register with the wireless LAN and exchange data with other mobile clients and access points. One such wireless LAN protocol is the Institute of Electrical and Electronics Engineers (IEEE) 802.11b standard protocol which supports clients roaming within buildings such as homes, offices, hotels and airports using direct sequence spread spectrum radios with data rates up to 11 Mbps in the 2.4 GHz band.

FIG. 1 is a wireless LAN 104 including a host 100 (access point) and a plurality of clients 102. Each of the plurality of clients communicates with the host over the wireless LAN and clients communicate with each other through the host. The transmission data rate from the host to a client is dependent on distance between the host and the client and the location of the client with respect to the host. For example, even though two clients are at the same distance from the host their transmission rates can be different if there are obstacles in the direct communications path between the host and the respective client.

Typically the plurality of clients share one common channel to the host, and thus the overall system throughput is dependent on the distribution of transmission rates to clients. Throughput on the wireless LAN is reduced because clients with high data rates must wait for access to the channel while slower clients communicate over the channel.

FIG. 2 is a graph illustrating system throughput with respect to the number of clients communicating with a single-channel Access Point (AP) over a standard IEEE 80.11b wireless LAN. The IEEE 802.11b supports four different data transmission rates (1, 2.2, 5 and 11 Mbps.) In this example, it is assumed that each of the ten clients can only use a 1 or 11 Mbps transmission rate. It is also assumed that there is no overhead in the packet transmission; that is, each packet transmission only includes data and there is no inter-packet spacing. If a client with a 1 Mbps data rate uses 11t seconds, a client with an 11 Mbps data rate uses t seconds to transmit the same amount of data. Thus, the system throughput can be calculated as follows:

$$system throughput = \frac{{n}_{1} * 11 t * 1 Mpbs + {n}_{2} * t * 11 Mbps}{{n}_{1} * 11 t + {n}_{2} * t}$$

where n₁ is the number of clients with a data transmission rate of 1 Mbps, and n₂ is the number of clients with a data transmission rate of 11 Mbps.

As shown in the graph of FIG. 2, if the data rate of all clients is 11 Mbps, the system throughput is 11 Mbps and if the data transmission rate of all clients is 1 Mbps, the system throughput is 1 Mbps. However, if only one of the ten clients has a 1 Mbps data transmission rate, the system throughput drops by about 50%. For example, with one client (n₁) having a transmission rate of 1 Mbps and 9 (n₂) clients with a transmission rate of 11 Mbps, the system throughput is computed as follows:

$$system throughput = \frac{1 * 11 + 9 * 11}{1 * 11 + 9 * 1} = \frac{110}{20} = 5.5 Mbps$$

FIG. 3 illustrates a wireless LAN 300 with a single-channel access point 302 and ten clients located at various distances around the access point 302.

Only one access channel is available at the access point (the host). The two clients 304, 306 closest to the access point 302 have the highest data transmission rate, that is, 11 Mbps. Client 308 has a data transmission rate of 5.5 Mbps, clients 310, 312 and 314 have a data transmission rate of 2 Mbps and clients 316, 318, 320 and 322 furthest from the access point have the lowest data rate, that is, 1 Mbps. In a simulation conducted with an IEEE 802.11b network simulator, the simulated overall system throughput taking overhead into account is 1.31 Mbps.

### SUMMARY OF THE INVENTION

System throughput of a wireless network can be improved by using multi-channel systems (access points). For example, the IEEE 802.11b standard protocol that operates in the 2.4 GHz band has adequate spectrum to provide three independent non-overlapping channels, each having a different center frequency. However, if clients are randomly assigned to channels, the overall system throughput is still dependent on the distribution of transmission rates to clients. This is analogous to a highway with multiple lanes in which both slow and fast vehicles can travel in any of the lanes. The overall throughput of the highway is dependent on the speed of the slowest vehicles in each lane. Thus, the overall system throughput of a multi-channel system with random assignment of clients to channels is about three times the system throughput of a single channel system.

System throughput is improved significantly by using an intelligent channel association scheme to associate clients to channels based on data rate. A measure of the data rate of communication with a client is determined. The client is associated to one of the plurality of channels based on the determined data rate.

A data rate is assigned to each of a plurality of channels. The measure of the data rate may be the actual rate data is received or transmitted or a running average of the transmit, receive or both rates. Data rate may be determined by measuring an average data rate of a received packet from a client by sensing average power of received data packets and the measured data rate may be stored. The client is associated with a second channel by de-authenticating the client from a first channel and allowing the client to authenticate with the second channel.

In one embodiment, the wireless network uses the IEEE 802.11b standard protocol with three channels and provides data rates of 1, 2, 5.5 and 11 Mbps. In an alternate embodiment, the wireless network uses the IEEE 802.11a standard protocol with eight channels and data rates of 6, 9, 12, 18, 24, 36, 48 and 54 Mbps.

A channel may be assigned to a type of packet. The data rate assigned to a channel may be a range.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a wireless LAN 104 including a host (access point) and a plurality of clients;

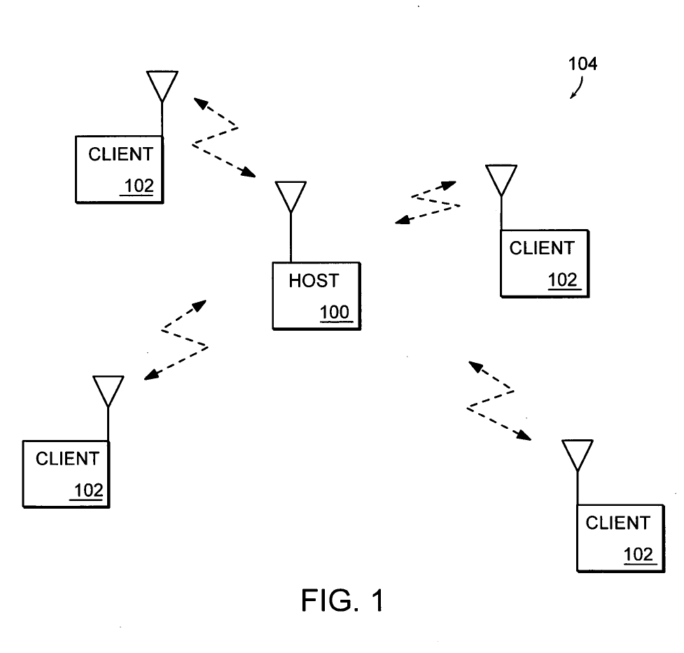

FIG. 2 is a graph illustrating system throughput with respect to the number of clients communicating with a single channel access point (AP) over a standard IEEE 80.11b wireless LAN;

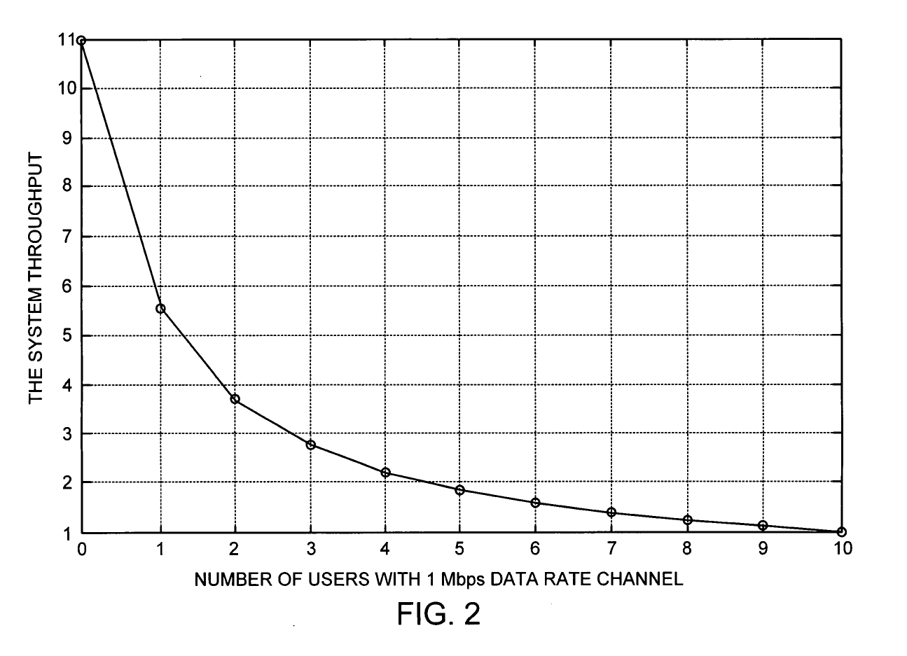

FIG. 3 illustrates a wireless LAN with a single-channel access point and ten clients located around the access point;

FIG. 4 illustrates three independent non-overlapping channels within a 2.4 GHz band used by the IEEE 802.11b standard protocol;

FIG. 5 illustrates an IEEE 802.11b wireless network with a multi-channel access point and thirty clients located around the access point with clients associated with channels according to the principles of the present invention;

FIG. 6 is a flowchart illustrating a method for assigning clients to channels.

FIG. 7 is a block diagram of a typical access point that performs a bridging function between a wireless network and a wired network; and

FIG. 8 is a block diagram of an embodiment of the wireless network interface shown in FIG. 7.

### DETAILED DESCRIPTION OF THE INVENTION

A description of preferred embodiments of the invention follows.

Several wireless communication protocols and their associated bands allow communication systems to simultaneously use multiple channels within the band. For example, the IEEE 802.11b standard supports three independent non-overlapping RF channels and four different data rates (1, 2, 5.5 and 11 Mbps), allowing simultaneous communication on three different channels. Thus, bandwidth to an access point is increased by allowing clients to communicate simultaneously on three independent channels.

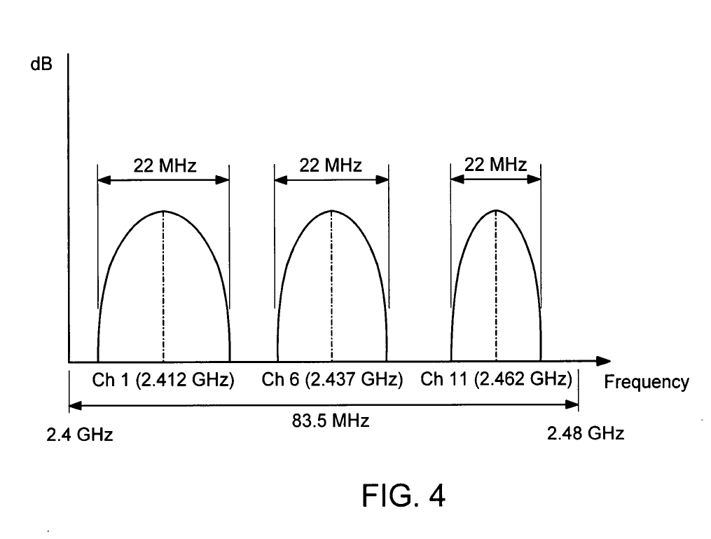

FIG. 4 illustrates three independent non-overlapping channels within a 2.4 GHz band used by the IEEE 802.11b standard protocol. The IEEE 802.11b standard protocol provides fourteen overlapping channels of 22 MHz in an 83.5 MHz range between 2.4 GHz and 2.48 GHz, with channel centers spaced about 5 MHz apart. The 83.5 MHz range, referred to as the 2.4 GHz band can accommodate three non-overlapping 22 MHz channels simultaneously. The center frequencies for three (1, 6, 11) of the 14 overlapping 22 MHz channels are chosen to provide the three independent non-overlapping 22 MHz channels. Data can be independently transmitted and received at data rates up to 11 Mbps on each of the three non-overlapping channels.

The IEEE 802.11a standard protocol uses a different portion of the frequency spectrum (the 5 GHz Unlicenced National Information Structure (UNII) band) and provides eight center frequencies for eight independent channels between 5.15 and 5.35 GHz at data rates of up to 54 Mbps on each of the eight channels.

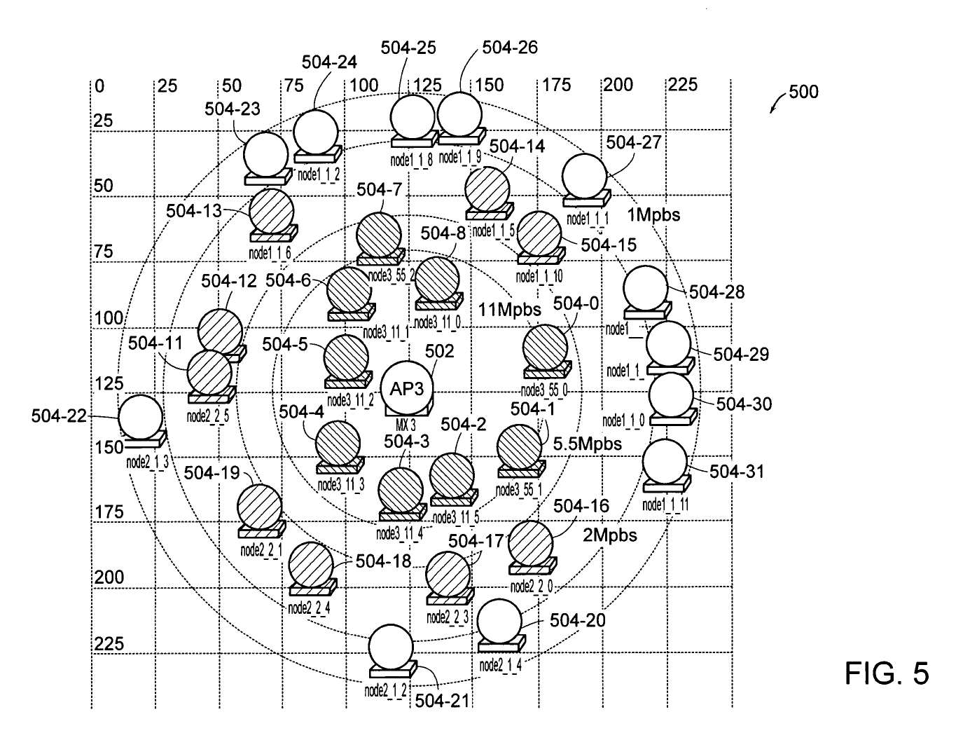

System throughput is increased by intelligently associating clients with available channels. FIG. 5 illustrates an IEEE 802.11b standard protocol wireless network 500 with a multi-channel system (access point) 502 and thirty clients 504_0-504_31 located at various distances around the access point. The access point intelligently associates clients with channels according to the principles of the present invention.

In a wireless communications system with M clients, N different data rates and L channels available, the maximum channel throughput of the lth channel regardless of the system overhead, with n₁, n₂, . . . nₘ clients at the data transmission rates of r₁, r₂, . . . , rₘ respectively, is given by:

$$system throughput on l th channel = \frac{{\sum }_{i = 1}^{m} {n}_{i}}{{\sum }_{i = 1}^{m} {n}_{i} / {r}_{i}}$$

The total system throughput is the sum of the throughput of each access channel. Thus, throughput is increased by associating clients with a similar transmission data rate with the same channel.

For example, in a configuration with 2 channels (L=2), 10 clients (M=10) and two data transmission rates (N=2), 4 of the clients have a data rate of 1 Mbps and 6 of the clients have a data rate of 11 Mbps and each of the clients can be assigned to one of the two channels. The system throughput is increased by assigning the 6 clients with 11 Mbps data rate to channel 1 and the 4 clients with 1 Mbps data rate to channel 2. The system throughput on channel 1 is 11 Mbps and the system throughput on channel 2 is 1 Mbps. Thus, the average system throughput is 12 Mbps (the sum of the throughput of each channel (1 Mbps+11 Mbps)).

In contrast, for the same configuration with the prior art random assignment of clients to channels, the average system throughput is only 7.2867 Mbps. Thus, the intelligent assignment scheme provides about 64% system capacity improvement over the system throughput of the random channel assignment scheme.

Assuming 4 of the clients have a data rate of 1 Mbps and six of the clients have a data rate of 11 Mbps and there are five clients associated with each channel, there are five possible random assignments. The average system throughput is computed by averaging the system throughput of the five possible random assignments of the ten clients with 1 Mbps and 11 Mbps data rates to channels as shown in Table 1 below:

TABLE 1

| Assignment | 1 | 2 | 3 | 4 | 5 |
|---|---|---|---|---|---|
| channel 1: | (5, 0) | (4, 1) | (3, 2) | (2, 3) | (1, 4) |
| channel 2: | (0, 4) | (2, 3) | (3, 2) | (4, 1) | (5, 0) |

In assignment 1, the five clients associated with channel 1 transmit at 11 Mbps and of the five clients associated with channel 2, one transmits at 11 Mbps and the other four transmit at 1 Mbps. In assignment 2, of the five clients associated with channel 1, four transmit at 11 Mbps and one transmits at 1 Mbps. Of the five clients associated with channel 2, two transmit at 11 Mbps and 3 transmit at 1 Mbps. In assignment 3, of the five clients associated with channel 1, three transmit at 11 Mbps and two transmit at 1 Mbps. Of the five clients associated with channel 2, three transmit at 11 Mbps and 2 transmit at 1 Mbps. Assignment 4 is the same as assignment 1 and assignment 5 is the same as assignment 2, with the channels reversed.

Thus, the system throughput of each channel can be calculated as follows:

$$system throughput = \frac{{n}_{1} * 11 t * 1 Mpbs + {n}_{2} * t * 11 Mbps}{{n}_{1} * 11 t + {n}_{2} * t}$$

where n₁ is the number of clients with a data transmission rate of 1 Mbps, and n₂ is the number of clients with a data transmission rate of 11 Mbps.

In assignment 1, the throughput is 12.222 Mbps. In assignment 2, the throughput is 5.2381 Mbps and in assignment 3, the throughput is 4.4000 Mbps. The throughput of assignment 4, and 5 are the same as the throughput of assignments 1 and 2. Thus, the average system throughput is the average of the first three assignments: (12.222+5.2381+4.400)/3=7.2867 Mbps.

In the configuration shown in FIG. 5, there are three available channels for the 30 clients, 12 clients 504-20-504_31 have a data rate of 1 Mbps, 9 clients 504_19-504_11 have a data rate of 2 Mbps, 3 clients have a data rate of 5.5 Mbps 504_0, 504_1, 504_7 and 6 clients have a data rate of 11 Mbps 504_2-504_6 and 504_8. The clients are intelligently associated with channels, such that clients with similar data rates are associated with the same channel. With three available channels, rates are assigned to channels, data transmission rate 1 Mbps is assigned to channel 1, data transmission rates 2 Mbps and 5.5 Mbps are assigned to channel 2 and data transmission rate 11 Mbps is assigned to channel 2. Clients are associated with the channels such that, the 12 clients with a data rate of 1 Mbps are associated with channel 1, the 9 clients with a data rate of 2 Mbps and the 3 clients with a data rate of 5 Mbps are associated with channel 2 and the 6 clients with a data rate of 11 Mbps are associated with channel 3.

In a simulation conducted based on the IEEE 802.11b standard network protocol with a network simulator taking the system overhead (header and inter-packet delays) into account, the simulated overall system throughput for an intelligent association of clients with channels with this association of channels to clients is 5.878 Mbps. Network simulators used to simulate wireless networks are well-known to those skilled in the art.

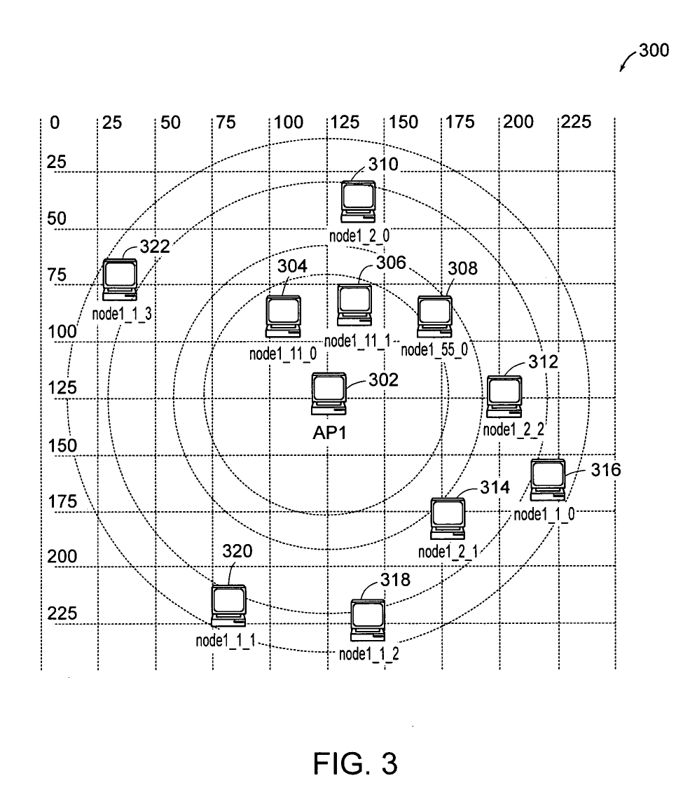

Using the same network simulator to measure system throughput for the single-channel access point described in conjunction with FIG. 3, the average system throughput measured for ten clients is 1.31 Mbps, and for 30 clients is 3.93 Mbps (1.31 Mbps*3). Thus, for the configuration shown in FIG. 5, the channel association scheme improves the overall system throughput by about 50% over the conventional random assignment scheme.

The improvement over the random assignment scheme increases as the number of clients, available data rates and the number of channels are increased. For example, an IEEE 802.11a standard wireless LAN supports eight data rates (6, 9, 12, 18, 24, 36, 48 and 54 Mbps) and eight non-overlapping independent channels. An IEEE 802.11g standard wireless LAN supports three non-overlapping channels and eight data rates (6, 9, 12, 18, 24, 36, 48 and 54 Mbps).

Clients in a wireless network are mobile and can connect with different access points as they move through the wireless network. A client typically hops among the available channels until it receives a response from the access point. On each hop, the client emits a “beacon” signal to signal its presence to an access point. Access points typically have some form of power detection to determine whether to accept transmission from a client. The access point will not accept transmission from a client if the signal is too weak, indicating that the client is too far away from the access point. If the client does not receive a response, the client continues to hop among the available channels to attempt to find an access point, until assigned a channel.

A wireless LAN is identified by a 32 character unique identifier (service set identifier (SSID)). All access points and clients in the WLAN include the SSID assigned to the WLAN in the header of packets transmitted over the WLAN. Prior to initiating data transmission, a client must be associated with an access point. After a client receives a response from an access point, the client transmits an authentication control frame to the access point. The authentication control frame is used to verify the identity of the client and the access point. A de-authentication control frame transmitted by the access point is used to notify a client of the termination of the authentication.

An access point 502 controls the channel to which it will associate with a particular client 504. Channel assignment in the IEEE 802.11 protocol can be performed by refusing to communicate with the client on a particular channel and waiting for the client to hop to a better channel before responding.

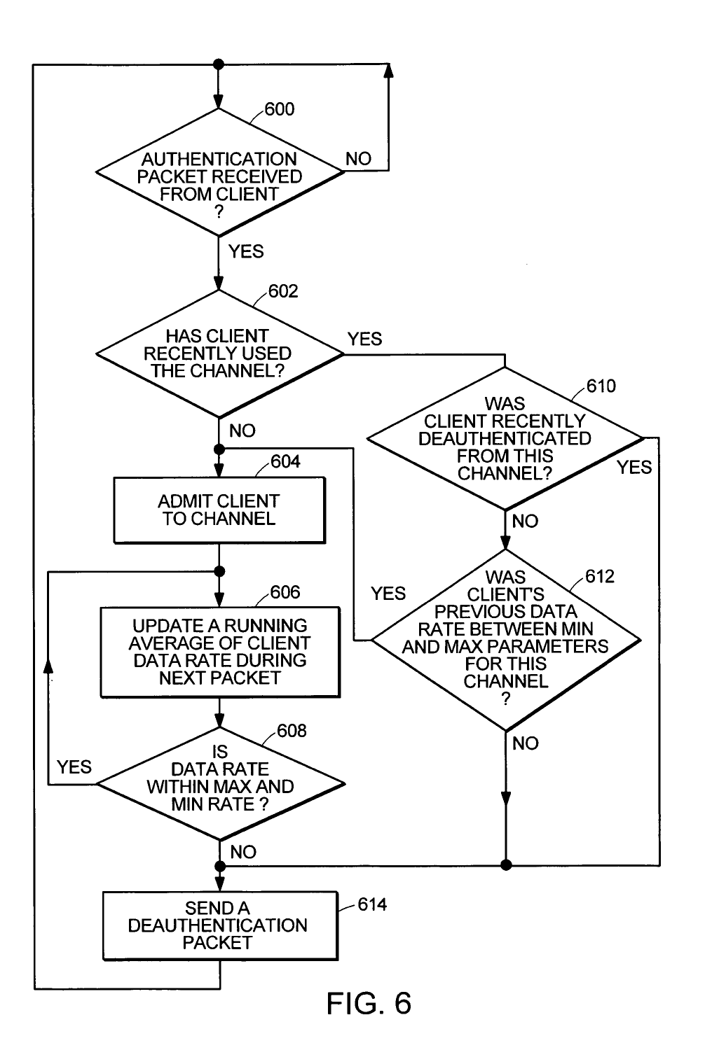

FIG. 6 is a flowchart illustrating the operation of a channel association routine for intelligently associating clients to channels in a multi-channel access point.

At step 600, the access point waits to receive an authentication packet from a client. Association between the client and the access point is possible after a successful authentication. Once association is successful, the client may exchange data frames with the access point. Association and authentication frames and beacon signals used in wireless communications and described in the IEEE 802.11 standard are well-known to those skilled in the art.

The client must re-associate with the AP by sending an authentication packet at the start of each transmission, which may be for every frame/packet or after a series of frames have been transmitted. Upon receiving an authentication packet, processing continues with step 602.

At step 602, the access point checks to see if the client has recently used the access point. If the client has recently used the access point, a client data structure associated with the client is stored in memory, and processing continues with step 610. If the client has not recently used the access point, processing continues with step 604.

At step 604, the access point admits the client to the access point. Prior to associating with the access point, the client first determines which rate is good for its transmission based on distance from the access point by detecting power of signals received from the access point. Initially, the client transmits at the maximum possible rate. The client is admitted based on detected power of signals received from the client.

For example, the AP may only support a distance of 60 meters for a signal of −60 dB. Thus, clients are admitted based on strength of the received data signal from 0 dB to −60 dB. A client data structure is allocated in memory for the client and the channel assigned to the client is stored in the structure. In one embodiment, the access point admits the client to the channel irrespective of the initial data rate at which the client transmits. In an alternate embodiment, the access point determines the best data rate of the client based on detected power and will only admit the client if this rate is assigned to the channel. Processing continues with step 606.

At step 606, after admitting a client to a virtual access point, the channel association routine in the access point updates a running average of the client data rate during the next received data packet. The channel association routine stored in memory and executed by a processor in the access point periodically monitors the client's average data rate. The power of the received packet is an indication of the data transfer rate. The power is also an indication of distance of the client from the access powered because typically clients closer to the access point transmit at a higher data rate. However, this is not an accurate measurement of distance because there may be something blocking the direct path of the client to the access point resulting in attenuation of the signal.

The running average of the access point to client actual data rate based on detected power is stored by the configuration routine in a client data structure that is associated with the client and stored in memory. The running average is computed based on detected power of prior packets received from the client. For example, if the access point has received nine packets from a client, the average power for the tenth packet is the sum of the detected power for the previous nine packets and the tenth packet divided by the number of packets ((p1+p2+p3+ . . . p10)/10). The performance (such as, Signal to Noise Ratio (SNR), Bit Error Rate (BER), and Frame Error Rate (FER)) of each client is also an indication of the data rate. It is also possible to use the actual rate at which the data was received and transmitted to compute a measure for the rate of the channel. Also, a running average can be computed using either or both rates in a similar way to the average power by considering a number of the last data packets. Processing continues with step 608.

At step 608, the access point checks if the measured data rate is within the maximum and minimum range assigned for the channel. Each channel is assigned a data rate or range of data rates during configuration of the access point. Data rates can be entered by a user through a configuration routine that communicates with a user interface. In one embodiment, the graphical user interface is a web based Graphical Client Interface that allows a maximum desired rate and a minimum desired rate for each channel to be set. The desired rates entered through the user interface are stored by the configuration routine in memory in the access point. Web based Graphical Client Interfaces are well-known to those skilled in the art.

If the average rate is within the range, processing continues with step 606, to continue to monitor the transmit range. If the average data rate of any client falls outside a client specified range, processing continues with step 614 to force the client to re-associate on another channel. The client can attempt to re-associate with the access point on another channel.

At step 610, the access point checks the client data structure to determine if the client was recently de-authenticated from the channel. If the client attempts to re-authenticate with the same channel the authentication is denied, forcing the client to find another channel and processing continues with step 614. If the client was not recently de-authenticated from the channel, the client can re-associate with the channel and processing continues with step 612.

At step 612, the client attempts to re-authenticate on a channel, the client's old transmission rate is checked against the maximum and minimum parameters for that channel. If the old transmission rate is outside the range then processing continues with step 614 to deny the authentication.

At step 614, a de-authentication packet is sent to the client, effectively forcing the client from the channel, and forcing the client to re-associate. The client can then try to associate with another channel. If a client has not re-authenticated after a timeout period, the client data structure for the client is no longer stored in memory, effectively allowing the client to re-authenticate on any channel in the access point the next time the client tries to re-authenticate. Processing continues with step 600, to wait to receive an authentication packet from a client.

Thus, the Intelligent channel association allows local movement of clients among channels, by shifting clients whose data rates have fallen below some threshold to one channel, while shifting clients with high data rates to another. A network of access points with intelligent channel association can be used to optimize throughput of the wireless network, with each access point optimizing throughput of clients associated with the particular access point.

The addition of virtual access points to the physical access point increases the number of networks supported by an access point. A virtual access point is a logical entity within a physical access point. The virtual access points allow one physical access point to offer access to different networks. Each virtual access point appears to be an independent physical access point and has a unique SSID and separate authentication.

In one embodiment, each channel in the access point can support four virtual access points, each with a different SSID allowing four different networks to be supported on each channel. For example, one of the four networks may be the engineering network with access to design files while another may be the marketing network with access to customer lists and another network may be a guest network offering access to the Internet. The aggregate throughput over all the channels is greatly improved by assigning slow clients to one channel while the faster clients are assigned to another channel.

Intelligent channel association associates a group of clients that are connected at similar rates onto particular virtual access points (VAPs), thereby preventing the fast clients being slowed by slower clients. For example, VAPs 0, 1, 2, 3 use channel 1; VAPs 4, 5, 6, 7 use channel 2 and VAPs 8, 9, 10, 11 use channel 3. For example, if the data rate range of VAP1 is set from 24 Mbps to 54 Mbps, and the data rate range of VAP8 is set from 1 Mbps to 24 Mbps, all the fast clients are associated with VAP1 and the slower clients are associated with VAP8. Each VAP is assigned a unique SSID so that a client can be moved to a different RF channel after the ICA system has moved it from a given virtual AP.

The maximum desired rate, minimum desired rate and SSIDs are configured such that there are is an appropriate new VAP for a client that the ICA system has moved from a VAP. For example, if one VAP has a maximum and minimum desired rate of 24 to 54 Mbps, there is another VAP on a different RF channel with a range of 1 to 36 Mbps. The overlap between the ranges assigned to each channel is selected so that a client with a data rate within the overlapping range does not oscillate between channels.

In alternate embodiments, clients can be associated with channels based on traffic type, and traffic load in order to increase the performance of the wireless LAN. For example, isochronous traffic types such as Voice over Wireless Protocol (VoWIP) can be intelligently assigned to dedicated channels to ensure a level of guaranteed service. Additionally, a multi-channel AP that supports the IEEE 802.11a 54 Mbps data rate and the IEEE 802.11b 11 Mbps data rate can dedicate a channel to slower clients such as 802.11b or those far away from the AP, thereby reserving other channels to clients associated at higher rates. Clients can be associated with channels based on monitoring the traffic load. For example, clients with data transfer rates of 11 Mbps can be distributed evenly over more than one channel dependent on the traffic load so that each client receives more bandwidth.

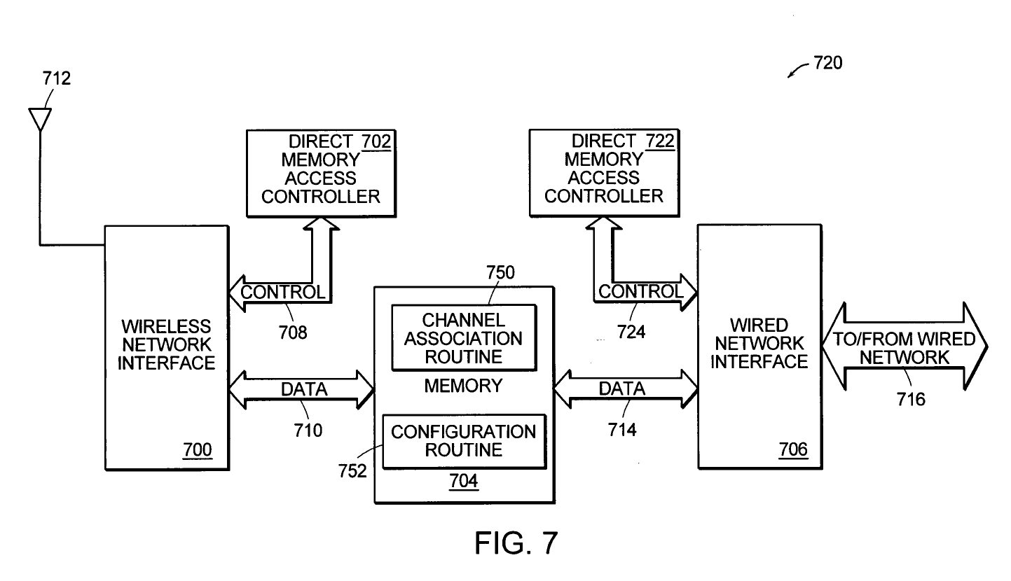

FIG. 7 is a block diagram of a multi-channel access point 720 that performs a bridging function between a wireless network and a wired network.

A wireless network interface 700 communicates with remote clients through antenna 712. Data received from the wireless network by the wireless network interface 700 is stored in memory 704, by Direct Memory Access (DMA) Controller 702 through control signals 708, over data bus 710 prior to transferring to the wired network through wired network interface 706. Client data structures, the channel association routine 750 and the configuration routine 752 are also stored in the memory.

Data received by the wired network interface from the wired network 716 is stored in memory 704, by Direct Memory Access (DMA) Controller 722 through control signals 724, over data bus 714 prior to being transmitted by the wireless network interface 700 through antenna 712 to the wireless network.

Thus, the access point 720 allows wireless clients to download and upload data from/to clients on a wired network. Access points can communicate over the wired network, for example, to synchronize predetermined transfer periods on the wired network. Wireless clients can communicate with each other through the access point 720 with data received from a source client temporarily stored in memory 704 prior to forwarding to a destination client

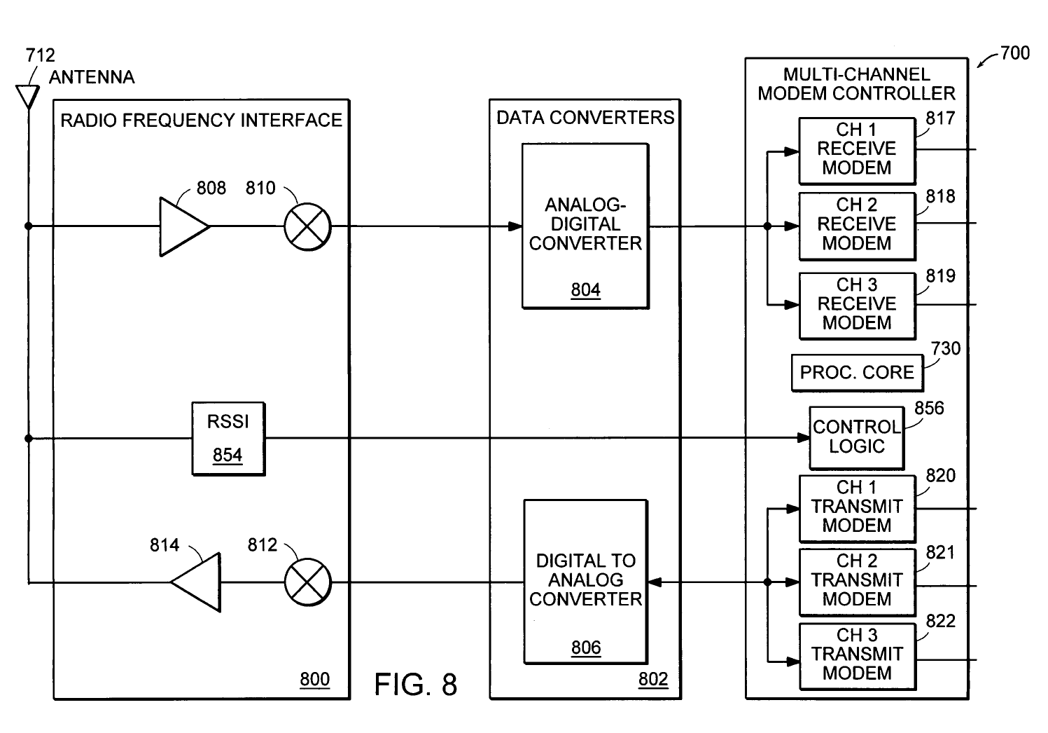

FIG. 8 is a block diagram of an embodiment of the wireless network interface 700 shown in FIG. 7. Signals received by the antenna 712 from mobile clients are coupled to a low noise amplifier 806. The amplified signals are coupled to a down convert mixer 810 that converts high frequency signals to low frequency signals. The amplified and down converted signal is coupled to an analog-digital converter 804 in the signal conversion circuit 802 to convert the amplified analog signal to a digital signal.

The multi-channel controller 803 includes a respective receive modem 817, 818, 819 per channel and a respective transmit modem 820, 821, 822 per channel. The digital signal output from the analog-digital converter 804 is coupled to each of the receive modems 817, 818, 819 to extract the digital signal from each channel that can be simultaneously transmitted. Each receive modem operates at a different center frequency. For example, in an embodiment for an IEEE 802.11b wireless network, one of the receive modems operates at the center frequency for channel 1, the second operates at the center frequency for channel 6 and the third operates at the center frequency for channel 11.

Downloads to mobile clients on the wireless network originate in the transmit modems. Each of the transmit modems 820, 821, 822 is configured to transmit on a different channel having a respective center frequency. Simultaneous transmission on all three channels is permitted. The output of each of the transmit modems 820, 821, 822 is coupled to the digital to analog converter 806 for conversion to an analog signal to be transmitted over the wireless network through antenna 712.

The analog signal output from the digital-analog converter 806 is coupled to an up convert mixer 812. An amplifier 814 coupled to an up convert mixer amplifies the respective analog signal. The radio frequency interface 800 also includes a Received Signal Strength Indication Circuit (RSSI) 954 coupled to the antenna 712 for detecting the power of received signals. The strength of the signal is an indication of the average power of the received signals. Clients are associated with a data transmission rate based on the power of received signals. A processor core 730 in the modem controller 803 executes routines stored in memory 804 to intelligently associate clients with channels in the access point as described in conjunction with FIG. 6.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for assigning clients to channels in a multi-channel system for communicating with clients over a wireless network comprising the steps of:
determining a measure of a data rate of communication with a client; and
associating the client to one of a plurality of channels based on the determined data rate.

2. The method of claim 1, further comprising:
assigning a data rate to each of a plurality of channels.

3. The method of claim 1, wherein the step of determining further comprises:
measuring an average data rate of a received packet from a client.

4. The method of claim 1, wherein the step of determining further comprises:
measuring the data rate of received data.

5. The method of claim 4, wherein the step of determining further comprises:
measuring an average data rate of the received data.

6. The method of claim 1, wherein the step of determining further comprises:
measuring the data rate of transmitted data.

7. The method of claim 6, wherein the step of determining further comprises:
measuring an average data rate of the transmitted data.

8. The method of claim 1, wherein the step of determining further comprises
measuring data rate of received data;
measuring data rate of transmitted data; and
using an average of the measured transmitted data rate and measured received data rate.

9. The method of claim 3, wherein the step of measuring further comprises:
sensing average power of received data packets.

10. The method of claim 3, wherein the step of associating further comprises:
storing the measured data rate.

11. The method of claim 1 wherein the step of associating further comprises:
de-authenticating the client from a first channel; and
allowing the client to authenticate with a second channel.

12. The method of claim 1, wherein the wireless network uses the IEEE 802.11b standard protocol.

13. The method of claim 12, wherein available data rates are 1, 2, 5.5 and 11 Mbps.

14. The method of claim 13, wherein the number of channels is three.

15. The method of claim 1, wherein the wireless network uses the IEEE 802.11a standard protocol.

16. The method of claim 15, wherein the available data rates are 6, 9, 12, 18, 24, 36, 48 and 54 Mbps.

17. The method of claim 16, wherein the number of channels is three.

18. The method of claim 2, wherein the step of assigning further comprises:
assigning a type of data packet to a channel.

19. The method of claim 2, wherein the assigned data rate includes a range of rates.

20. A multi-channel system for communicating with clients over a wireless network comprising:
a channel association routine which determines a measure of a data rate of communication with a client and associates the client to one of a plurality of channels based on the determined data rate.

21. The multi-channel system of claim 20, further comprising:
a configuration routine which assigns a data rate to each of a plurality of channels.

22. The multi-channel system of claim 20, further comprising:
a receive signal strength indicator which senses average power of received data packets.

23. The multi-channel system of claim 20 further comprising:
memory for storing the determined data rate.

24. The multi-channel system of claim 20 wherein the channel association routine moves a client to a second channel by de-authenticating the client from a first channel and allowing the client to authenticated with the second channel.

25. The multi-channel system of claim 20, wherein the wireless local area network uses the IEEE 802.11b standard protocol.

26. The multi-channel system of claim 25, wherein available data rates are 1, 2, 5.5 and 11 Mbps.

27. The multi-channel system of claim 26, wherein the number of channels is three.

28. The multi-channel system of claim 20, wherein the wireless network uses the IEEE 802.11b standard protocol.

29. The multi-channel system of claim 28, wherein the available data rates are 6, 9, 12, 18, 24, 36, 48 and 54 Mbps.

30. The multi-channel system of claim 29, wherein the number of channels is three.

31. The multi-channel system of claim 21, wherein the configuration routine assigns a type of traffic to a channel.

32. The multi-channel system of claim 20, wherein the data rate is a range of rates.

33. A multi-channel system for communicating with clients over a wireless network comprising:
means for determining a measure of a data rate of communication with a client; and
means for associating the client to one of the plurality of channels based on the determined data rate.
